(19) United States
(12) Patent Application Publication
(10) Pub. No.: US 2025/0133187 A1
(43) Pub. Date: Apr. 24, 2025

(54) SYSTEM AND METHOD FOR PROVIDING CONTACT INFORMATION FOR A VEHICLE

(71) Applicants: HYUNDAI MOTOR COMPANY, Seoul (KR); KIA CORPORATION, Seoul (KR)

(72) Inventor: Dong Cheol Jo, Cheonan-si (KR)

(73) Assignees: HYUNDAI MOTOR COMPANY, Seoul (KR); KIA CORPORATION, Seoul (KR)

(21) Appl. No.: 18/614,214

(22) Filed: Mar. 22, 2024

(30) Foreign Application Priority Data
Oct. 19, 2023 (KR) 10-2023-0140162

(51) Int. Cl. H04N 7/18; G06F 3/14; G06V 20/56; G06V 40/10; H04W 4/48; H04W 12/06

(52) U.S. Cl. CPC H04N 7/18; G06F 3/14; H04W 12/06; G06V 20/56; G06V 40/10; H04W 4/48

(57) ABSTRACT

A system and a method display contact information for a vehicle owner when the vehicle is parked or stopped. The system includes a display disposed in the vehicle so that the display is recognizable from an outside of the vehicle, an operation unit configured to select information displayed on the display, a camera configured to record the outside of the vehicle, and a controller configured to communicate with the display, the operation unit, and the camera. The controller is configured to display information, selected based on a selection of the operation unit, on the display as output information and to output the output information on the display when a preset recognition condition is satisfied based on recorded information recorded by the camera.

### CROSS-REFERENCE TO RELATED APPLICATION

This application claims, under 35 U.S.C. § 119 (a), the benefit of and priority to Korean Patent Application No. 10-2023-0140162, filed on Oct. 19, 2023, the entire contents of which are incorporated herein by reference.

### TECHNICAL FIELD

The present disclosure relates to a system and method for providing contact information for a vehicle. More particularly, it relates to technology for displaying contact information for a vehicle owner while parked or stopped.

### BACKGROUND

A driver of a vehicle may place a sign having contact information of the driver in the vehicle since it may be necessary to contact the driver in case of double parking due to limited parking space or in an emergency situation, such as an accident.

However, since personal information, such as a mobile phone number of the driver, is exposed to the outside at all times, personal information may be misused, which may cause trouble for the driver. As a phone number of a person contacting the driver is also exposed to the driver due to a caller ID, privacy of both parties may be violated.

Accordingly, recently, rather than directly displaying a phone number of a driver, a one-time and virtual secured phone number or QR (quick-response code) code connectable to a phone of the driver may be installed in a vehicle. See Korean Patent Publication No. 10-2458958 (Registration date: Oct. 20, 2022)

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to solve the above-described problems associated with the prior art.

A system and a method are disclosed for providing contact information of a vehicle, where the system and method are capable of protecting personal information of a driver and a person calling the driver.

A system and a method are disclosed for providing contact information of a vehicle, where the system and method have increased convenience in displaying contact information of a driver in the vehicle.

In particular, a system and a method are disclosed or providing contact information of a vehicle, where the system and method offer usability and safety in a shared car.

The objects of the present disclosure are not limited to the objects mentioned above. Other objects not mentioned herein may be more clearly understood by one having ordinary skill in the art to which the present disclosure belongs from the description below.

To achieve the above-described objects of the present disclosure and perform characteristic functions of the present disclosure described herein, features of the present disclosure are as follows.

In one aspect, the present disclosure provides a system for providing contact information for of a vehicle. The system includes a display disposed in the vehicle so that the display is recognizable from outside the vehicle. The system also has an operation unit configured to select information to be displayed on the display and a camera configured to record the outside of the vehicle as recorded information. The system also includes a controller configured to communicate with the display, the operation unit, and the camera. The controller is configured to display the selected information on the display as output information and to output the output information on the display when a preset recognition condition is satisfied based on the recorded information recorded by the camera.

In another aspect, the present disclosure provides a method of providing contact information for a vehicle. The method includes selecting, by an operation unit, output information to be displayed on a display provided in the vehicle and facing outside the vehicle. The method also includes displaying the output information by a controller that is configured to communicate with the operation unit and the display. Displaying the output information includes determining, by the controller, whether a preset recognition condition is satisfied based on recorded information that is recorded by a camera configured to record the outside of the vehicle and includes displaying, by the controller, the output information upon determining that the recognition condition is satisfied.

Other aspects and embodiments of the disclosure are discussed below.

It is to be understood that the terms “vehicle” or “vehicular” or other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a configuration diagram of a system for providing contact information for a vehicle according to an embodiment of the present disclosure; and

FIGS. 2-5 illustrate flowcharts of methods of providing contact information for a vehicle according to various embodiments of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

Specific structural or functional descriptions presented in the embodiments of the present disclosure are only illustrative for the purpose of describing embodiments according to the concept of the present disclosure. The embodiments according to the concept of the present disclosure may be implemented in various forms. In addition, the present disclosure should not be construed as being limited to the embodiments described herein. The disclosed embodiments should be understood to include all modifications, equivalents, and substitutes included in the spirit and scope of the present disclosure.

Meanwhile, in the present disclosure, even though terms such as “first,” “second,” etc., may be used to describe various elements, the elements are not limited by these terms. These terms are only used to distinguish one element from another. For example, within the scope of rights according to the concept of the present disclosure, a first element may be referred to as a second element, and similarly, the second element may be referred to as the first element.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween. Other expressions for describing a relationship between elements, i.e., expressions, such as “between” and “immediately between” or “adjacent to” and “directly adjacent to,” should be interpreted similarly.

Like reference numerals refer to like elements throughout the written description and drawings. The terminology used herein is for the purpose of describing the embodiments and is not intended to limit the present disclosure. In the present specification, a singular expression includes the plural form unless the context clearly dictates otherwise. Referring to expressions “comprises”, “comprising”, “has”, “having, “includes”, and/or “including” and variations thereof used in the specification, a mentioned component, step, operation, and/or element does not exclude the presence or addition of one or more other components, steps, operations, and/or elements.

Hereinafter, embodiments of the present disclosure are described in detail with reference to the attached drawings. When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

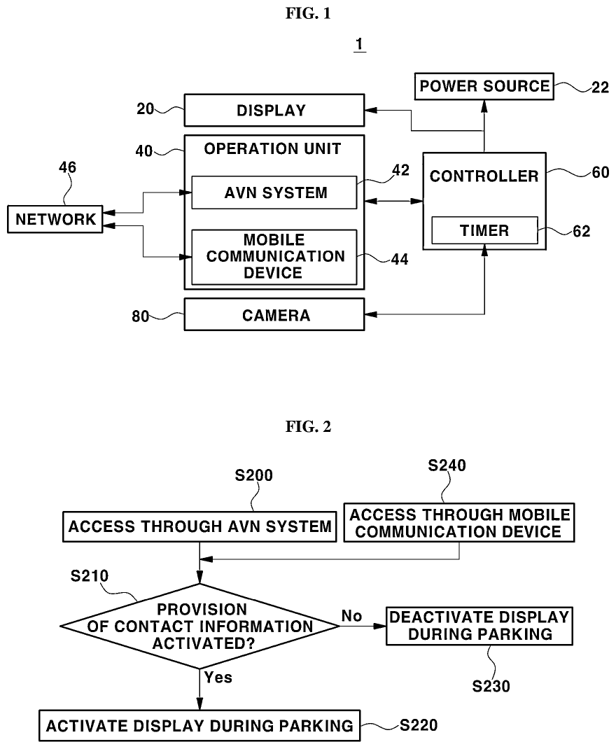

As shown in FIG. 1, a system 1 for providing contact information for a vehicle according to the present disclosure includes a display 20, an operation unit 40, and a controller 60. The display 20 is configured to display information to be displayed by a driver of the vehicle. In some embodiments, a skin or theme selected by the driver may be displayed on the display 20. In some embodiments, the skin displayed on the display 20 may be a skin where a screen having a red background is displayed for a preset time, e.g., 1 second, and the display 20 is turned off for a preset time, e.g., 30 seconds, to serve as a security indicator. In some embodiments, contact information, such as a mobile phone number selected by the driver, may be displayed on the display 20. In some embodiments, a QR code that may connect with a mobile phone of the driver may be displayed on the display 20. In some embodiments, any combination thereof may be displayed on the display 20.

To this end, the display 20 may be installed in the vehicle so that the display 20 may be recognized and viewed from outside the vehicle. The display 20 may be placed inside the vehicle to face the outside of the vehicle and, for example, may be installed on a crash pad.

The display 20 may be an always on display (AOD). In the AOD, certain information may be displayed on the display 20 even when the screen of the display 20 is in an off state. In addition, the display 20 may be configured to output the screen constantly or intermittently depending on settings. In one embodiment, a size of the display 20 may be selected according to a given condition. As the size of the display 20 increases, lifespan of a battery supplying power to the display 20 decreases, so a range of approximately 1.5 to 2 inches may be appropriate.

Power may be supplied to the display 20 by a power source 22. For example, the power source 22 may be a separate power source for operation of the display 20. In addition, the power source 22 may be a battery rechargeable from an auxiliary battery of the vehicle.

The operation unit 40 may be configured to communicate with the display 20 to serve as an interface allowing the driver to select information to be displayed on the display 20. For instance, the operation unit 40 may be an audio, video, navigation (AVN) system 42 of the vehicle. In some embodiments, the operation unit 40 may be a mobile communication device 44. The mobile communication device 44 may be an electronic device, such as a smartphone, capable of communicating with the AVN system 42 of the vehicle. A skin, a phone number, or a QR code to be output to the display 20 may be edited and selected through the operation unit 40.

In some embodiments, the operation unit 40 may include both the AVN system 42 and the mobile communication device 44. The AVN system 42 and the mobile communication device 44 may be configured to communicate through a set network 46. For example, output information selected from the AVN system 42 or the mobile communication device 44 may be displayed on the display 20. In some embodiments, an application for controlling the display 20 may be installed in the mobile communication device 44. Moreover, the application may be an application configured to control the AVN system 42 of each vehicle.

The controller 60 may communicate with the display 20 and the operation unit 40. The controller 60 may process information input by the operation unit 40 and display information to be displayed on the display 20. Additionally, the controller 60 may control an operation of the power source 22 that supplies power to the display 20. The controller 60 includes a processor and a memory capable of collecting, processing, and storing information by the display 20, the operation unit 40, and a camera 80.

The controller 60 may be provided as separate controllers that control each of the display 20 and the operation unit 40 or may be an integrated controller that integrally controls the display 20 and the operation unit 40 together. The controller 60 may also be integrated within another controller of the vehicle.

The controller 60 may also communicate with the vehicle. For instance, the controller 60 may communicate with components in the vehicle through a Controller Area Network (CAN). The controller 60 may thereby verify whether the vehicle is in a parked state.

The controller 60 may include a timer 62. The timer 62 may measure the passage of time. For example, the output information displayed on the display 20 may automatically change based on an elapsed time after the vehicle is parked. In this instance, the timer 62 may measure time elapsed from when the vehicle is parked through a CAN signal.

According to some embodiments of the present disclosure, the system 1 may include the camera 80. The camera 80 may be a built-in camera provided in the vehicle. The built-in camera may be a built-in camera installed in the vehicle to record videos while the vehicle is driving or parked. In some embodiments, the camera 80 may be a camera installed in the vehicle and detachable from the vehicle configured to communicate with the controller 60.

The camera 80 is configured to record the outside of the vehicle, i.e., all or a part of the environment surrounding or outside of the vehicle. For example, the camera 80 may recognize a face of a person that approaches the vehicle to acquire information displayed on the display 20. According to the present disclosure, when a face of a person is recognized to some extent by the camera 80, the contact information of the driver or output information selected by the driver may be displayed on the display 20 only when the person is detected for a certain period of time. In this way, it is possible to improve safety by preventing personal information of the driver of the vehicle from being misused. For example, when the controller 60 determines through artificial intelligence, such as deep learning, that a dangerous situation, such as when the person holds a weapon, may occur based on an image acquired by the camera 80, the controller 60 may control the display not to display the contact information.

The camera 80 may include a camera controller for the camera 80 that is separate from the controller 60. In this case, the controller 60 may be configured to communicate with the camera controller and transmit a request. In some embodiments, the controller 60 may be integrated with the camera controller so that the camera 80 may be directly controlled by the controller 60.

Various controls may be possible with the system 1 according to the present disclosure.

As shown in FIG. 2, an operation of the system 1 may be initiated by the AVN system 42 of the vehicle. The driver may activate provision of contact information through the AVN system 42 at operation S200. In some embodiments, provision of contact information may be activated through the mobile communication device 44 at operation S240. At operation S210, whether to activate the display 20 may be selected in an application in the AVN system 42 or the mobile communication device 44. When activation is selected (YES in operation S210), the display 20 is in an operable state at operation S220. When activation is not selected (NO in operation S210), the display 20 may not operate, may not display information, or may be deactivated during parking at operation S230.

In some embodiments, when the contact information is displayed on the display 20, using the AVN system 42 of the vehicle as the operation unit 40, the output information to be output to the display 20 may be input or a skin may be selected on the AVN system 42 of the vehicle while the vehicle is in a driving or stopped state. For example, the information to be output may be a phone number of the vehicle driver, a virtual safety number indicating the phone number, a QR code indicating the phone number, a text message, such as “I am parking for a while,” or the like.

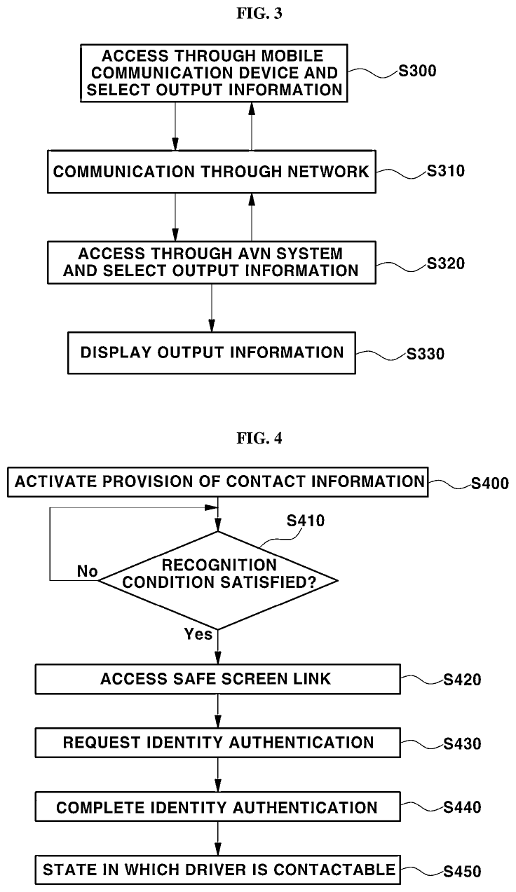

As shown in FIG. 3, in some embodiments, in the case of operation by the mobile communication device 44 configured to communicate with the controller 60 or the AVN system 42 of the vehicle, the information or skin to be output on the display 20 may be selected by the mobile communication device 44 (for example, through an application) while the vehicle is stopped or parked at operation S300. The selected information to be output may be transmitted to the controller 60 via the AVN system 42 through the network 46 at operations S310 and S320. The controller 60 may output information to be displayed on the display 20 based thereon at operation S300.

In some embodiments, operation by the system 1 may include the following case.

As shown in FIG. 4, the system 1 according to the present disclosure may enable another party trying to contact or connect with the driver of the vehicle when an identity of the other party has been verified.

At operation S400, the provision of vehicle contact information is activated by the AVN system 42 or the mobile communication device 44. During this period, the camera 80 may record the surroundings of the vehicle and transmit the recorded information to the controller 60. The controller 60 determines whether a recognition condition is satisfied based on the transmitted recorded information at operation S410. For example, the controller 60 may determine that the recognition condition is satisfied (YES in operation S410) when the other party approaches the vehicle and stays for a certain period of time. Also, the controller 60 may determine that the recognition condition is satisfied when a certain range in the face of the other party is recognized. When the recognition condition is not satisfied (NO in operation S410), the controller 60 may prohibit output of the display 20. Upon determining that the recognition condition is satisfied, the controller 60 activates the display 20 to display a safe screen link at operation S420. When the other party accesses an authentication page via a mobile communication device of the other party through the safe screen link, identity authentication is requested (S430). Here, the authentication page may be displayed on an application installed in the mobile communication device of the other party. Here, the application installed in the mobile communication device of the driver and the application installed in the mobile communication device of the other party may be same and may communicate with each other through a known communication network. In some embodiments, the authentication page may be a webpage. When the other party completes the preset identity authentication at operation S440, the contact information of the driver is provided to the other party through the application or a text message, and the driver may be in a contactable state at operation S450. The contact information of the driver may be a virtual phone number that can be linked to a smartphone of the driver, etc. In addition, the other person may send a text message, etc. to the driver. Additionally, the phone number of the other party may be converted into a secured number and displayed on the mobile phone of the driver. Other safe or secure contact information display methods or solutions may also be utilized. The driver of the vehicle may receive a push message, a call, or the like, through the application of the mobile communication device 44. These message and phone connection records may be configured to be stored for a certain period of time.

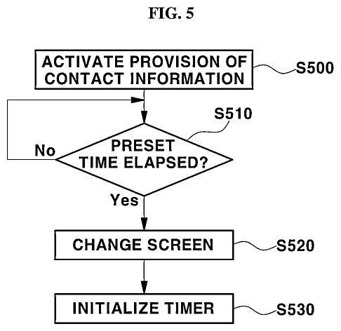

According to some embodiments of the present disclosure, as shown in FIG. 5, the output information displayed on the display 20 may automatically change at regular intervals.

At operation S500, the system 1 according to the present disclosure is activated. The controller 60 receives input of a time elapsed from when the vehicle was parked from the timer 62. The controller 60 is configured to determine whether the elapsed time is a preset time at operation S510. Upon determining that the preset time has elapsed after the vehicle was parked, the controller 60 automatically changes the output information on the display 20 at operation S520. For example, when the output information is a secured number representing the contact information of the driver, the secured number is changed to another secured number. As another example, when the output information is a QR code representing the contact information of the driver, the QR code is changed to another QR code. Furthermore, when the driver sets the screen to be changed in advance, the controller 60 may change the output information of the display 20 to the corresponding screen. After the screen is changed, the controller 60 initializes the timer 62 to measure the elapsed time from a time when the screen is changed at operation S530. When a preset time has elapsed from this time point, the controller 60 may automatically change the screen.

In some embodiments, in the case of a short-term parking state when automatically changing the screen, if the display 20 is connected to the auxiliary battery of the vehicle, the display 20 may be turned on at all times, and the secured number or QR code may be automatically changed at preset times by the controller 60. In some embodiments, if the vehicle is in a long-term parking state when automatically changing the screen, the controller 60 may turn on/off and output a finally stored secured number, QR code, or the like under a certain condition. In some embodiments, when automatically changing the screen, if the vehicle is started and the power source 22 for the display 20 is charged by the auxiliary battery of the vehicle, the controller 60 may automatically change the screen again.

In the case of a conventional phone number display board that operates by being charged by a battery or solar energy, it is difficult for the user to change a number once set case by case. However, the present disclosure may include a display to directly change and expose the phone number to be displayed in the vehicle, even in a shared car, such as a rental vehicle.

In addition, according to the present disclosure, the lifespan of the battery for the display may be increased since on/off of the display is controllable.

According to the present disclosure, safety is improved since the contact information is exposed only when the face of the other person who wants to know the contact information for the vehicle driver is recognized within a certain range.

According to the present disclosure, safety is improved since the secured number exposed to the outside of the vehicle may be automatically changed on a regular basis.

The present disclosure provides a system and method for providing contact information for a vehicle, where the system and method are capable of protecting personal information of a driver and a person calling the driver.

The present disclosure provides a system and method for providing contact information for a vehicle, where the system and method have increased convenience in displaying contact information of a driver in the vehicle.

The present disclosure provides a system and method for providing contact information for a vehicle, where the system and method offer usability and safety, particularly in a shared car.

The effects of the present disclosure are not limited to those described above. Other effects not mentioned herein should be more clearly recognized by those of ordinary skill in the art from the above description.

The technical concept of the present disclosure described above is not limited to the above-described embodiments and the accompanying drawings. It should be clear to those of ordinary skill in the art that various substitutions, modifications, and changes are possible without departing from the technical spirit of the present disclosure.

What is claimed is:

1. A system for providing contact information for a vehicle, the system comprising:
a display disposed in the vehicle so that the display is recognizable from outside the vehicle;
an operation unit configured to select information to be displayed on the display;
a camera configured to record the outside of the vehicle as recorded information; and
a controller configured to communicate with the display, the operation unit, and the camera, wherein the controller is configured to:
display the selected information on the display as output information, and
output the output information on the display when a preset recognition condition is satisfied based on the recorded information.

2. The system of claim 1, wherein the display is an Always on Display (AOD).

3. The system of claim 1, wherein the operation unit is an Audio, Video, Navigation (AVN) system of the vehicle configured to communicate with the display or a first mobile communication device that is configured to communicate with the AVN system.

4. The system of claim 1, wherein the output information includes contact information of a driver of the vehicle.

5. The system of claim 4, wherein the contact information is output as a virtual number or Quick Response (QR) code linkable to the contact information of the driver of the vehicle.

6. The system of claim 1, wherein:
the output information includes an identity authentication request link; and
the controller is configured so that, in response to a request for a connection to the identity authentication request link by a second mobile communication device, an identity authentication page is displayed on the second mobile communication device.

7. The system of claim 6, wherein, when identity authentication is completed through the identity authentication page on the second mobile communication device, the controller allows the second mobile communication device to access contact information of a driver in the output information.

8. The system of claim 7, wherein an identification number of the second mobile communication device displayed in connection with the contact information is a virtual number.

9. The system of claim 1, wherein the recognition condition is passage of a preset time or when a person recorded by the camera is recognizable.

10. The system of claim 1, wherein the controller includes a timer configured to measure an elapsed time from a time point when the vehicle is parked, and wherein the controller changes the output information when the elapsed time measured by the timer exceeds a preset time.

11. A method of providing contact information for a vehicle, the method comprising:
selecting, by an operation unit, output information to be displayed on a display provided in the vehicle and facing outside the vehicle; and
displaying the output information by a controller configured to communicate with the operation unit and the display,
wherein displaying the output information includes
determining, by the controller, whether a preset recognition condition is satisfied based on recorded information recorded by a camera configured to record the outside of the vehicle, and
displaying, by the controller, the output information upon determining that the recognition condition is satisfied.

12. The method of claim 11, wherein the operation unit is an AVN system of the vehicle configured to communicate with the display or a first mobile communication device that is configured to communicate with the AVN system.

13. The method of claim 11, wherein the output information includes contact information of a driver of the vehicle.

14. The method of claim 13, where the contact information is output as a virtual number or Quick Response (QR) code linkable to the contact information of the driver of the vehicle.

15. The method of claim 11, further comprising displaying, by the controller, an identity authentication request link as the output information.

16. The method of claim 15, further comprising displaying, by the controller, contact information of the vehicle on the display as the output information when identity authentication is completed in a second mobile communication device accessing the identity authentication request link.

17. The method of claim 15, further comprising:
collecting, by the controller, an elapsed time from a time point when the vehicle is parked or stopped; and
automatically changing, by the controller, the output information upon determining that the elapsed time exceeds a preset time.
